(19) United States
(12) Patent Application Publication
(10) Pub. No.: US 2007/0056840 A1
(43) Pub. Date: Mar. 15, 2007

(54) MODIFIED PROCESS FOR SYNTHESIS OR PEROVSKITE CERAMICS

(75) Inventors: Athawale Anjali ANAND, Pune (IN); Chandwadkar Asha Jeevan, Pune (IN); Sahu Prashant Kumar, Pune (IN)

Correspondence Address: FOLEY AND LARDNER LLP;SUITE 500, 3000 K STREET NW, WASHINGTON, DC, 20007, US

(73) Assignee: COUNCIL OF SCIENTIFIC AND INDUSTRIAL RESEARCH

(21) Appl. No.: 11/278,296

(22) Filed: Mar. 31, 2006

(30) Foreign Application Priority Data
Mar. 31, 2005 (IN) 0803/DEL/2005

(51) Int. Cl. A62D 3/00

(52) U.S. Cl. 204/157.43

(57) ABSTRACT

The present invention relates to a process for the synthesis of perovskite ceramics and more particularly relates to the preparation of perovskites with general formula LnMO₃, where Ln represents lanthanide element and M a transition metal.

### FIELD OF THE INVENTION

The present invention relates to a process for the synthesis of perovskite ceramics. More particularly relates to the preparation of perovskites with general formula LnMO₃, where Ln represents lanthanide element and M a transition metal. The perovskites have been synthesized using the principles of propellant chemistry, in the presence of a microwave field, without the requirement of further heat treatment for the phase formation.

### BACKGROUND OF THE INVENTION

Perovskites, in general, can be represented by the general formula ABO₃, where the larger cation A has a do-decahedral co-ordination and the smaller cation B has a six-fold coordination. The B-site cation is surrounded octahedrally by oxygen atoms, while the A-site cation is located centrally in the cavity made by these octahedra.

Perovskite-type oxides containing transition metals are attracting great attention as catalyst for complete oxidation of hydrocarbons, purification of waste gases as well as electrochemical reduction of oxygen. Another important application of these materials is their use as sensors for toxic exhaust gases like CO, NOₓ, SOₓ etc., alongwith humidity and hydrogen. The generation of lattice defects due to partial substitution of cations in the A-site (A₁₋ₓA′ₓBO₃), B-site (AB_{1-y}B′_{y}O₃) or both A and B-site cations (A₁₋ₓA′ₓB_{1-y}B′_{y}O₃) impart the properties required for catalytic activity and sensing behavior. By judiciously varying the amount and nature of these substituents, one can control the oxidation state of the transition metal (the redox properties required for catalytic activity) and the oxygen stoichiometry (δ).

The conventional method for the synthesis of LnMO₃ perovskites includes mixing and grinding of the oxide powders, followed by solid-state reaction at high temperature (1500-1700° C.) for the development of the perovskite phase. This method bears several drawbacks, such as high reaction temperature, large particle size, limited chemical homogeneity and low-sinterability, which consequently have detrimental effect on the catalytic and sensing properties of these materials.

Various attempts have been made to synthesize finer and homogeneous powders including the low-temperature chemical methods namely, sol-gel, polyacrylamide gel, hydroxide coprecipitation, spray pyrolysis, polymerization route, mechanochemical route etc. It is therefore, an object of the invention to produce fine powders in a system, which minimizes energy consumption. Another object of the present invention is rapid synthesis of fine powders without the need of expensive capital equipment.

More recently, combustion synthesis has been preferentially used for obtaining many ceramic materials, using various combinations of fuel and/or oxidizers [S. S. Manoharan and K. C. Patil, Combustion route to fine particle perovskite oxides, J. Solid State Chem., 102 (1993), 267-276; M. V. Kuznetsov, Q. A. Pankhurst, I. P. Parkin and Y. G Morozov, Self-propagating high-temperature synthesis of chromium substituted lanthanum orthoferrites LaFe₁₋ₓCrₓO₃ (0≦x≦1), J. Mater. Chem. 11(3), (2001) 854-858.

The major drawbacks while processing perovskite ceramics through above-mentioned chemical routes are:
(1) Post-treatment of the as-synthesized powder samples is required at temperatures ranging between 600-1200° C. for a period of 2-12 hours to obtain the appropriate phase.
(2) These chemical routes are time-consuming as they require hours for the chemical reaction to occur, followed by subsequent post-treatment for few hours again.
(3) Due to the requirement of heat-treatment of the as-synthesized samples after the chemical reaction for the desired phase formation, the energy consumption due to the expensive heating furnaces is quite high, and hence these methods are not energy efficient.
(4) The requirement of the post-synthesis heat-treatment of the as-synthesized materials in these chemical routes does not make these processes environment-friendly.
(5) Also, the particles formed are usually agglomerated after the heat-treatment step, although the powder samples may be homogeneous in some cases depending upon the type of chemical synthesis route.
(6) Agglomeration in the final product leads to reduction in the specific surface area of the materials, and hence deterioration in the physical properties required for specialized applications like catalytic activity, sensing and other electroceramic applications.

Hence, a need still exists for an easy, inexpensive, and reliable way to synthesize LnMO₃ perovskite ceramics using simple instrumentation, low energy and shorter reaction times. An advantage of the chemical routes to synthesize ceramic materials is that the synthesized materials are chemically homogenous, and the methods usually provide a good control over the microstructure of the ceramic materials.

The application of microwave energy to process various kinds of materials in an efficient, economic and effective manner is emerging as an innovative technology. Many patents and publications have reported the microwave processing of advanced materials with some accounting for the special apparatus used for generating and concentrating the microwave radiations during the course of the reaction (M. Susumu, Y. Minowa and H. Komura, Microwave heating oven, U.S. Pat. No. 4,307,277, December 22, (1981); A. C. Johnson, R. J. Lauf, D. W. Bible, R. J. Markunas, Apparatus and method for microwave processing of materials U.S. Pat. No. 5,521,360 May 28, 1996; J. D. Gelorme, D. A. Lewis, J. M. Shaw, Microwave processing, U.S. Pat. No. 5,317,081, May 31, 1994).

Microwave-assisted process is a novel technique, used for the fast and controlled processing of the advanced polymeric (D. A. Scola, X. Fang, S. Huang; and E. Vaccaro, Microwave synthesis of polyamides, polyesters, and polyamideesters U.S. Pat. No. 6,515,040 (2003)) and ceramic materials (D. E. Clark, A. Iftikhar, R. C. Dalton, Combustion synthesis of materials using microwave energy, PCT Int. Appl. WO 9013513 (1990); Y.-P. Fu and C.-H. Lin, Preparation of CeₓZr₁₋ₓO₂ powders by microwave-induced combustion process, J. Alloys Compd. 354(1-2), (2003) 232-235; J. Huang, H. Zhuang and W. Li, Synthesis of nano-sized barium hexaferrite by microwave-induced low-temperature combustion, Chinese Patent CN 1378996 (2002)).

Microwaves are electro-magnetic radiations having frequency in the range of 0.3 to 300 GHz, with corresponding wavelength of 1 mm-1 m. Microwaves have a practical industrial range between ˜500 MHz to 10 Hz. However, in the synthesis of LnMO₃ perovskites, the frequencies are selected based on the energy required for the reaction. Today, only narrow bands of frequencies centered at 915 MHz and at 2.45 GHz are permitted by regulation for industrial and scientific applications without a special license. In the present invention, a 2.45 GHz microwave source is used for material synthesis and processing, as the energy associated with 915 MHz is found to be too low to carry out any chemical reaction leading to materials synthesis,

Microwave heating is fundamentally different from other heating process. In conventional heating, the heat generated by the heating element is transferred to the sample surfaces by radiation/convection. On the contrary, in the microwave process, heat is generated internally within the material, rather than originating from the external heating sources (Y. Matsubara, Method of producing heat with microwaves, U.S. Pat. No. 4,822,966 Apr. 18, 1989). Microwave heating is a sensitive function not only of the material of the article being processed but also depends on such factors as the size, geometry and mass of the article. Microwaves can be transmitted, absorbed or reflected, depending on the material type with which they interact. The microwave dielectric heating effect arises from the natural ability of certain substances to efficiently absorb and then subsequently transform the electromagnetic energy into heat. Localized microwave heating results in a rapid reaction rate. The presence of strong microwave absorbing properties of one of the constituent reactants leads to a sudden rise in temperature within few minutes, resulting in chemical reaction between the constituent reactants leading to an in situ phase formation.

There are many materials that do not couple well with microwave radiation at low temperatures. Since the use of microwaves for material synthesis or sintering rests heavily on the microwave absorbing capacity of the material being processed, these ceramic materials have to be preheated by another heating source. One preheating source that has been used is a secondary microwave susceptor (microwave absorber) such as a bed of certain susceptor materials packed around the ceramic material. For material synthesis using microwave inactive materials, the oxides of the constituent cations are compressed into a pellet or rod and encased in a SiC/graphite cavity, followed by subjection to microwave irradiation (S. Gedevanishvili, D. K. Agrawal, R. Roy and B. Vaidhyanathan, Microwave processing using highly microwave absorbing powdered material layers, U.S. Pat. No. 6,512,216, Jan. 28, 2003). Therefore, in such a case the reaction occurs through indirect transfer of heat from the heated graphite/SiC to the reactant oxides, thereby converting the reactant oxides into the products. However, both these methods yield products that show large degree of agglomeration and inhomogeniety.

### OBJECTS OF THE INVENTION

The main objective of the present invention is to provide an improved process for the microwave synthesis of perovskite ceramics that overcomes the limitations faced by the above conventional chemical routes and the “solid-state” microwave synthesis routes.

Another objective of the present invention is to provide a process wherein no further heat-treatment of the as-synthesized products for crystallization (phase formation) is required, as the ceramic materials synthesized are already phase formed, having the desired perovskite phases.

Yet another objective of the present invention is to provide a process wherein The perovskite oxides synthesized by this method have a much higher surface area as compared to the conventional combustion synthesis and microwave synthesis routes,

### SUMMARY OF THE INVENTION

The present invention relates to a process for the preparation of class of ceramics, especially the preparation of perovskites with general formula LnMO₃, where Ln represents lanthanide element and M a transition metal. The perovskites have been synthesized using the principles of propellant chemistry, in the presence of a microwave field, without the requirement of further heat treatment for the phase formation

TABLE 1
Comparison of Specific Surface area (in
m²/g) in different synthesis routes.

| | Microwave | Combustion | Present |
|---|---|---|---|
| Composition | Synthesis | Synthesis | Invention |
| LaMnO₃ | 0.65-0.8 | 0.8-1.2 | 4.2 |
| LaFeO₃ | 0.23-0.4 | 0.5-0.55 | 1.9 |
| LaNiO₃ | 0.5-0.7 | 0.5-0.8 | 3.8 |
| LaCoO₃ | 0.1-0.25 | 0.2-0.4 | 2.6 |

TABLE 2
Comparison of particle sizes of lanthanum-based perovskites.

| | Conventional | Present |
|---|---|---|
| Composition | Microwave Synthesis | Invention * |
| LaMnO₃ | 2.0-5.0 μm | 0.8-1.5 μm |
| LaFeO₃ | 3.0-10.0 μm | 0.5-1.0 μm |
| LaNiO₃ | 2.0-8.0 μm | 0.2-0.6 μm |
| LaCoO₃ | 2.5-10.0 μm | 0.1-0.25 μm |
| LaCrO3 | 1.5-3.0 μm | 0.2-0.5 μm |

* The particle sizes as observed in Scanning Electron Micrographs (SEM).

TABLE 3
Comparison of particle sizes of lanthanum-based perovskites.

| | | | Specific | Mean Particle |
|---|---|---|---|---|
| | Crystal | Density | Surface Area | Size^{#} |
| Composition | Structure | (g/cm³) | (m²/g) | (μm) |
| LaMnO₃ | Orthorhombic | 6.875 | 4.2 | 0.21 |
| LaFeO₃ | Orthorhombic | 6.640 | 1.9 | 0.32 |
| LaNiO₃ | Rhombohedral | 7.252 | 3.8 | 0.48 |
| LaCoO₃ | Rhombohedral | 7.287 | 2.6 | 0.22 |

^{#}The theoretical particle/agglomerate sizes were calculated from specific
surface area, assuming spherical particles, from the equation:
${D}_{BET} ( μm ) = \frac{6}{ρ ( g \text{/} {cm}^{3} ) \times S ( {m}^{2} \text{/} g )}$
(1) The as-synthesized powders are ultrafine in nature.
(2) The synthesized ceramic materials are very much phase pure, and no
impurity phases could be detected by the results of the X-ray diffraction
analyses given in table no 3-6.

TABLE 3
XRD data of LaFeO₃ synthesized by present invention.

| Sl. | Pos. | FWHM | d-value | Intensity | Crystallite | Plane |
|---|---|---|---|---|---|---|
| NO. | [°2θ] | [°2θ] | (A°) | ratio (I/Iₒ) | size (nm) | (hkl) |
| 1 | 23.660 | 0.329 | 3.752 | 38 | 24.4 | (012) |
| 2 | 33.620 | 0.329 | 2.6634 | 100 | 24.9 | (110) |
| 3 | 41.420 | 0.353 | 2.1781 | 51 | 23.8 | (006 (202) |
| 4 | 48.200 | 0.329 | 1.8864 | 42 | 26.2 | (024) |
| 5 | 54.260 | 0.376 | 1.6891 | 25 | 23.5 | (112)(116) |
| 6 | 59.920 | 0.400 | 1.5424 | 45 | 22.7 | (300)(214) |
| | | | | | | (018) |
| 7 | 70.360 | 0.329 | 1.3369 | 24 | 29.2 | (220)(208) |
| 8 | 75.180 | 0.259 | 1.2627 | 14 | 38.3 | (312)(1010) |

TABLE 4
XRD data of LaMnO₃ synthesized by the present invention.

| Sl. | Pos. | FWHM | d- value | Intensity | Crystallite | Plane |
|---|---|---|---|---|---|---|
| No. | [°2θ] | [°2θ] | (A°) | ratio (I/Iₒ) | size (nm) | (hkl) |
| 1 | 22.800 | 0.306 | 3.8969 | 14 | 26.2 | (100) |
| 2 | 32.460 | 0.282 | 2.7559 | 100 | 29.0 | (110) |
| 3 | 40.000 | 0.329 | 2.2521 | 23 | 25.4 | (111) |
| 4 | 46.600 | 0.329 | 1.9473 | 35 | 26.0 | (200) |
| 5 | 52.500 | 0.447 | 1.7415 | 12 | 19.6 | (210) |
| 6 | 57.880 | 0.518 | 1.5918 | 44 | 17.3 | (211) |
| 7 | 67.940 | 0.376 | 1.3780 | 22 | 25.2 | (220) |
| 8 | 72.660 | 0.447 | 1.3002 | 9 | 21.8 | (310) |
| 9 | 77.400 | 0.392 | 1.2319 | 18 | 25.7 | (311) |

TABLE 5
XRD data of LaNiO₃ synthesized by the present invention.

| Sl. | Pos. | FWHM | d- value | Intensity | Crystallite | Plane |
|---|---|---|---|---|---|---|
| No. | [°2θ] | [°2θ] | (A°) | ratio (I/Iₒ) | size (nm) | (hkl) |
| 1 | 23.320 | 0.282 | 3.8112 | 24 | 28.4 | (012) |
| 2 | 33.000 | 0.259 | 2.7120 | 87 | 31.6 | (110) |
| 3 | 33.400 | 0.259 | 2.6804 | 100 | 31.7 | (104) |
| 4 | 40.740 | 0.282 | 2.2129 | 32 | 29.7 | (202) |
| 5 | 47.620 | 0.306 | 2.1771 | 14 | 28.1 | (006) |
| 6 | 53.400 | 0.282 | 1.9080 | 81 | 31.2 | (024) |
| 7 | 53.400 | 0.424 | 1.7143 | 7 | 20.7 | (122) |
| 8 | 53.920 | 0.329 | 1.6990 | 9 | 26.8 | (116) |
| 9 | 59.080 | 0.329 | 1.5623 | 52 | 27.4 | (300)(214) |
| 10 | 59.880 | 0.306 | 1.5433 | 24 | 29.6 | (018) |
| 11 | 69.080 | 0.376 | 1.3585 | 20 | 25.4 | (220) |
| 12 | 70.040 | 0.376 | 1.3442 | 23 | 25.5 | (208) |
| 13 | 74.400 | 0.212 | 1.2740 | 7 | 46.5 | (306)(312) |
| | | | | | | (119) |
| 14 | 78.860 | 0.259 | 1.2127 | 17 | 30.8 | (134) |
| 15 | 79.540 | 0.259 | 1.2041 | 18 | 30.8 | (128) |
| 16 | 83.820 | 0.306 | 1.1531 | 7 | 34.5 | (042)(226) |
| 17 | 88.100 | 0.259 | 1.1078 | 13 | 42.2 | (404) |
| | 88.980 | 0.212 | 1.0991 | 5 | 51.9 | (0012) |

TABLE 6
XRD data of LaCoO₃ synthesized by the present invention.

| Sl. | Pos. | FWHM | d- value | Intensity | Crystallite | Plane |
|---|---|---|---|---|---|---|
| No. | [°2θ] | [°2θ] | (A°) | ratio (I/Iₒ) | size (nm) | (hkl) |
| 1 | 22.720 | 0.24 | 3.9107 | 15.05 | 33.4 | (012) |
| 2 | 26.060 | 0.288 | 3.4166 | 4.87 | 28.0 | (110) |
| 3 | 28.950 | 0.336 | 3.0817 | 5.64 | 24.1 | (104) |
| 4 | 29.895 | 0.192 | 2.9864 | 18.61 | 42.3 | (202) |
| 5 | 32.385 | 0.24 | 2.7623 | 100 | 34.1 | (006) |
| 6 | 39.400 | 0.192 | 2.2851 | 6.98 | 43.5 | (024) |
| 7 | 39.945 | 0.192 | 2.2552 | 18.04 | 43.5 | (122) |
| 8 | 46.060 | 0.192 | 1.9690 | 7.16 | 44.5 | (116) |
| 9 | 46.480 | 0.24 | 1.9522 | 23.84 | 35.6 | (300)(214) |
| 10 | 51.960 | 0.24 | 1.7584 | 5.48 | 36.4 | (018) |
| 11 | 52.395 | 0.24 | 1.7449 | 5.96 | 36.5 | (220) |
| 12 | 53.705 | 0.24 | 1.7054 | 2.8 | 36.7 | (208) |
| 13 | 55.365 | 0.336 | 1.6581 | 4.16 | 26.4 | (306)(312) |
| | | | | | | (119) |
| 14 | 57.770 | 0.288 | 1.5947 | 24.83 | 31.2 | (134) |
| 15 | 67.865 | 0.288 | 1.3799 | 8.66 | 32.9 | (128) |
| 16 | 72.450 | 1.152 | 1.3035 | 1.45 | 8.5 | (042)(226) |
| 17 | 77.280 | 0.432 | 1.2336 | 5.8 | 23.3 | (404) |

(1) Due to the initial solution-stage processing of the reactants, the process illustrated in the present invention results in products having chemical homogeneity and better structural uniformity, unlike the conventional microwave processing technologies.
(2) The present invention provides a process to produce materials having finer microstructure, and the method also provides a better control over tailoring the desired morphology by managing the fuel/oxidizer ratio and microstructure of the ceramic materials by varying the composition of the reaction system and the microwave-processing conditions.
(3) Microwaves provide rapid heating rates, which allows for faster chemical reactions.
(4) The as-synthesized products do not require heat-treatment (usually done in an electrical furnace) for several hours, so the present invention offers substantial energy savings and the additional infrastructural costs due to the heating arrangements.
(5) The overall processing time is much reduced by the use of microwave heating technology.
(6) The perovskite ceramic materials synthesized by the method illustrated in the present invention show improved catalytic and sensing properties, suitable for use in catalytic converters and as gas-sensing elements in gas sensors for toxic gases like CO and NOₓ.

### DETAILED DESCRIPTION OF THE INVENTION

Accordingly, the present invention provides a process for the synthesis of perovskite ceramics which comprises mixing of salts of lanthanide element and salts of transition metal, at least one external fuel, and optionally a chelating agent, in a polar solvent, subjecting the mixture to microwaves for at least 2 minutes to obtain a foamy mass of the product, subjecting the foamy mass to mechanical pressure to obtain the product in fine powder form.

In one of the embodiments of the present invention the polar solvent used for dispersing the lanthanide salts, transition metal salts, the external fuel(s) and optional chelating agent may be having a dielectric constant of at least 50, exemplified by water, tertiary alcohols or halogenated alcohols.

In another embodiment the salts of lanthanide element and transition metal may be such having oxidizing/reducing index≠0, exemplified by nitrates or organic salts containing 2 to 6 carbon atoms and/or 1-2 nitrogen atoms.

In another embodiment at least one of the salts of lanthanide or the transition metal should be a nitrate, which acts as one of the oxidizers during the redox reaction.

In yet another embodiment lanthanide element may be La, Sm, Ce having a stable +3 valence state in its most oxidized form.

In yet another embodiment, transition elements may belong to the first or second transition series, exemplified by Cr, Mn, Fe, Ni, Co, Cu.

In another embodiment, the external fuel contains 2 to 6 carbon atoms and/or 1-2 nitrogen atoms.

In still another embodiment, the molar ratio of the lanthanide and transition metals may be 0.5:1 to 2:1.

In another embodiment, the oxidizer to fuel ratio is at least 1:1 to 1:2.

In yet another embodiment, the chelating agent may be capable of serving as additional fuel exemplified by citric acid, acetic acid or ethyl acetoacetate.

In another embodiment, the process can be carried out varying microwave power levels, ranging from 20-80 percent, for varying times.

In another embodiment the microwave power may be incrementally increased by 10-20%, starting with 20%, if more than 40% power level is used for the reaction.

In yet another embodiment, the average particle size of perovskite ceramic powder obtained is in the range of 0.2-0.4 μm.

In yet another embodiment, the surface area of perovskite ceramic powder obtained is in the range of 1.9-4.2 m²/g.

In a feature of the present invention, the redox-reaction between the oxidizer and fuels, may be carried out by using a mixture of more than one fuel and/or oxidizers, still maintaining the same oxidizer to fuel ratio.

In still another feature, the time for which the whole “reaction system” containing the fuel and metal salts (oxidizers) dispersed/dissolved in a suitable solvent may be varied from 5-15 minutes, the actual redox-reaction occurring for 3-10 seconds, depending upon the kind of elements present.

In still another feature, the whole “reaction system” may be stirred as and when required for 5-10 minutes, inside or outside the microwave field, to homogenize the metal ions.

In yet another feature, the composition comprising of the reaction mixture and the solvent may require heating during the mixing process depending upon the composition of the reaction mixture and the whole volume of the solution.

In yet another feature, the microwave irradiation source is equipped with a stirring mechanism so that the reaction mixture can be homogenized in situ simultaneously, while irradiating the reaction mixture with microwaves.

### EXAMPLE 1

This example illustrates the preparation of LaNiO₃ perovskite. The starting materials that were used in the experiments carried out were of purchased from Loba Chemie (India) and were used as received. The water was double distilled before use. 3.464 grams La(NO₃)₃.6H₂O (assay >99%), 3.326 grams Ni(NO₃)₂.6H₂O (assay >99%) and 2.002 grams (NH₂)₂CO (assay 99%) were mixed with 25 ml of water and dissolved by stirring on a hot plate for 30 minutes to get concentrated, viscous gel. This gel was then transferred to a microwave transparent vessel and kept in microwave oven and then subjected to microwave irradiation (2.45 GHz frequency, 1350 Watts), initially for 5 minutes at 20% power level, then subsequently at 40% power level for the next 2 minutes and finally at 60% microwave intensity for 12 minutes for the final high temperature redox reaction (combustion). Finally at the end of the reaction about 1.9 grams of the desired LaNiO₃ phase was obtained. The oxidiser/fuel ratio used in this experiment was 1.0.

### EXAMPLE 2

This example illustrates the preparation of LaNiO₃ perovskite by using an oxidiser/fuel ratio of 0.80 as given in example 1.3.464 grams La(NO₃)₃.6H₂O, 3.326 grams Ni(NO₃)₂.6H₂O and 2.503 grams (NH₂)₂CO were mixed with 25 ml of water. After the evaporation of the solvent, the reaction mixture was transferred to the microwave oven and irradiated initially for 5 minutes at 20% power level followed by 40% power level for the next 2 minutes and finally at 80% power level for 8 minutes for the complete combustion. Finally about 1.9 grams of the desired LaNiO₃ phase was obtained.

### EXAMPLE 3

This example illustrates the preparation of LaMnO₃ perovskite as in example 1, using an organic salt of the transition metal containing 4 carbon atoms. 3.464 grams La(NO₃)₃.6H₂O, 1.961 grams Mn(CH₃COO)₂.4H₂O (assay 99.5%) and 0.480 grams (NH₂)₂CO were mixed with 20 ml of water. After the evaporation of the solvent and gelation on a hot plate for 30 minutes, the reaction mixture was irradiated in microwave oven at 20%, 40% and 60% power levels for 10, 5 and 2 minutes respectively, for the final combustion to take place. Finally about 1.91 grams of the desired LaMnO₃ phase was obtained. The oxidiser/fuel ratio used in this experiment was 0.68.

### EXAMPLE 4

This example illustrates the preparation of LaFeO₃ perovskite as in example 1, using another organic salt of the transition metal containing 12 carbon atoms 3.464 grams La(NO₃)₃.6H₂O, 2.441 grams C₆H₉FeO₇.3H₂O (assay 98%) and 0.480 grams (NH₂)₂CO were mixed with 25 ml of water. After the evaporation of the solvent and gelation on a hot plate for about 30 minutes, the reaction mixture was irradiated in microwave oven for 10 minutes at 20% power level, then subsequently at 40% power level for the next 2 minutes and finally at 80% microwave intensity for 3 minutes, until the final combustion reaction occurred. Finally, about 1.92 grams of the desired LaFeO₃ phase was obtained. The oxidiser/fuel ratio used in this experiment was 0.54.

### EXAMPLE 5

This example illustrates the preparation of LaCrO₃ perovskite as in example 1, using a nitrogen containing salt of the transition metal having 2 nitrogen atoms. 3.464 grams La(NO₃)₃.6H₂O, 2.682 grams ammonium dichromate (assay 99.5%) and 0.961 grams (NH₂)₂CO were mixed with 25 ml of water. After the evaporation of the solvent and gelation on a hot plate for about 30 minutes, the reaction mixture was irradiated in microwave oven at 20%, 40% and 80 power levels for 10, 3 and 4 minutes respectively for the final combustion to occur. Finally about 1.9 grams of the desired LaCrO₃ phase was obtained. The oxidiser/fuel ratio used in this experiment was 0.83.

### EXAMPLE 6

This example illustrates the preparation of LaNiO₃ perovskite as in example 1, using the organic salt of the lanthanide element containing 4 carbon atoms instead of the nitrates as in the above examples 3.592 grams La(CH₃COO)₃.4H₂O, 3.326 grams Ni(NO₃)₂.6H₂O (assay 99%) and 0.480 grams (NH₂)₂CO were mixed with 25 ml of water. After the evaporation of the solvent and gelation on a hot plate for about 30 minutes, the reaction mixture was irradiated in microwave oven for 10 minutes at 40% power level and finally at 80% microwave intensity for 4 minutes for combustion to occur. Finally about 1.9 grams of the desired LaNiO₃ phase was obtained. The oxidiser/fuel ratio used in this experiment was 0.33.

### EXAMPLE 7

This example illustrates the preparation of LaCrO₃ perovskite as in example 1, using NH₂CH₂COOH as the source of fuel instead of (NH₂)₂CO as in the above examples 3.464 grams La(NO₃)₃.6H₂O, 2.682 grams Cr(NO₃)₃.6H₂O (assay 99.5%) and 1.999 grams NH₂CH₂COOH were mixed with 25 ml of water. After the evaporation of the solvent and gelation on a hot plate for about 30 minutes, the reaction mixture was irradiated in a microwave oven at 40% and 80% power levels for 10 and 2 minutes respectively for the final combustion to occur. Finally about 1.95 grams of the desired LaCrO₃ phase was obtained. The oxidiser/fuel ratio used in this experiment was 1.0.

### EXAMPLE 8

This example illustrates the preparation of LaCoO₃ perovskite as in example 1, using a mixture of (NH₂)₂CO and NH₂CH₂COOH in the ratio 2:1 by weight as the source of fuel, instead of (NH₂)₂CO or NH₂CH₂COOH alone as in the above examples 3.464 grams La(NO₃)₃.6H₂O, 2.238 grams Co(NO₃)₂.6H₂O (assay 99.5%), 0.601 grams NH₂CH₂COOH and 0.721 grams (NH₂)₂CO were mixed with 30 ml of water. After the evaporation of the solvent and gelation on a hot plate for about 30 minutes, the reaction mixture was irradiated in microwave oven for 12 minutes at 40% power level, finally at 80% microwave intensity for 3 minutes for the final combustion to occur. Finally, about 1.96 grams of the desired LaCoO₃ phase was obtained. The oxidiser/fuel ratio used in this experiment was 0.83.

We claim:

1. A process for the preparation of perovskite ceramics which comprises mixing of salts of lanthanide element and salts of transition metal, at least one external fuel, and optionally a chelating agent, in a polar solvent, subjecting the above solution mixture to microwaves for at least 2 minutes to obtain a foamy mass of the product, subjecting the foamy mass to mechanical pressure to obtain the product in fine powder form.

2. A process as claimed in claim 1, wherein the polar solvent used has a dielectric constant of at least 50 and is selected from the group consisting of water, tertiary alcohols or halogenated alcohols.

3. A process as claimed in claim 1, wherein the salts of lanthanide element and transition metal used for oxidizing/reducing index≠0, and is selected from nitrates and organic salts containing 2 to 6 carbon atoms and/or 1-2 nitrogen atoms.

4. A process as claimed in claim 1, wherein at least one of the salts of lanthanide or the transition metal used is a nitrate.

5. A process as claimed in claim 1, wherein the nitrate of lanthanide or transition metal element used is an oxidizer.

6. A process as claimed in claim 1, wherein the lanthanide element used has a stable +3 valency state and is selected from the group consisting La, Sm, Ce.

7. A process as claimed in claim 1, wherein the transition element used is selected from first and second transition metal series.

8. A process as claimed in claim 1, wherein the transition element used is selected from the group consisting of Cr, Mn, Fe, Ni, Co, Cu.

9. A process as claimed in claim 1, wherein the external fuel contains 2 to 6 carbon atoms and/or 1-2 nitrogen atoms selected from [NH₂]₂CO, NH₂CH₂COOH. and a mixture thereof.

10. A process as claimed in claim 1, wherein the molar ratio of the lanthanide and transition metals is in the range of 0.5:1 to 2:1.

11. A process as claimed in claim 1, wherein the oxidizer to fuel ratio is in the range of 1:1 to 1:2.

12. A process as claimed in claim 1, wherein the chelating agent used is capable of serving as additional fuel selected from the group consisting of citric acid, acetic acid or ethyl acetoacetate.

13. A process as claimed in claim 1, wherein the microwave power levels used is in the range of 20-80 percent.

14. A process as claimed in claim 1, wherein the average particle size of perovskite ceramic powder obtained is in the range of 0.2-0.4 μm.

15. A process as claimed in claim 1, wherein the surface area of perovskite ceramic powder obtained is in the range of 1.9-4.2 m²/g.

16. A process as claimed in claim 1 wherein, the microwave power used is incrementally increased by 10-20%, starting with 20%, if more than 40% power level is used for the reaction.
